(19) United States
(12) Patent Application Publication
(10) Pub. No.: US 2007/0251282 A1
(43) Pub. Date: Nov. 1, 2007

(54) Dial for a combination lock

(76) Inventor: Chien-Yung Huang, Banchiao City (TW)

Correspondence Address: PRO-TECHTOR INTERNATIONAL SERVICES, 20775 NORADA CT., SARATOGA, CA, 95070, US

(21) Appl. No.: 11/784,246

(22) Filed: Apr. 5, 2007

(30) Foreign Application Priority Data
Apr. 27, 2006 (TW) 095115152

(51) Int. Cl. E05B 37/02

(52) U.S. Cl. 70/304

(57) ABSTRACT

The present invention provides a dial for a combination lock, which mainly includes a toothed wheel additionally configured on a side of conventional type dial provided with an internally mounted notched wheel. A plurality of external teeth are circum-located on an outer edge of the toothed wheel, and a center of another notched wheel is provided with a rotating shaft, lateral to which is provided with a notch. A plurality of teeth spacings circum-located on an outer edge of the notched wheel mutually engage with external teeth of the notched wheel of the dial. Accordingly, the dial is able to simultaneously actuate and rotate two notched wheels, thereby improving innovative effectiveness of the combination lock.

### BACKGROUND OF THE INVENTION

(a) Field of the Invention

The present invention relates to a dial for a combination lock, and more particularly to toothed wheel additionally configured on a dial, thereby enabling the dial to simultaneously actuate and rotate two notched wheels.

(b) Description of the Prior Art

There are an extensive range of conventional combination locks that primarily use a dial to actuate a notched wheel, such as combination padlocks, combination latch locks, suitcase combination locks, and so on, wherein one dial is merely able to actuate and rotate one notched wheel. The majority of conventional combination locks are provided with three dials, and the three dials are merely able to individually actuate and rotate a notched wheel on the inner edge thereof. Up to the present time, there is no device provided with functionality that enables a dial to simultaneously actuate and rotate two notched wheels.

### SUMMARY OF THE INVENTION

The present invention provides a dial for a combination lock, wherein a toothed wheel is additionally configured on a side of a dial, and external teeth are circum-located on an outer edge of the toothed wheel, whereby apart from the dial being able to actuate and rotate an original inner ring notched wheel, moreover, it is able to actuate and rotate another notched wheel by means of the external teeth of the toothed wheel, thereby forming an innovative device that enables the dial to actuate and rotate two notched wheels.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an exploded perspective view of the present invention.

FIG. 2 is a front sectional view of the present invention.

FIG. 3 is an elevational schematic view of the present invention.

FIG. 4 is another elevational schematic view of the present invention.

### DETAILED DESCRIPTION OF THE PREFERRED EMBODIMENTS

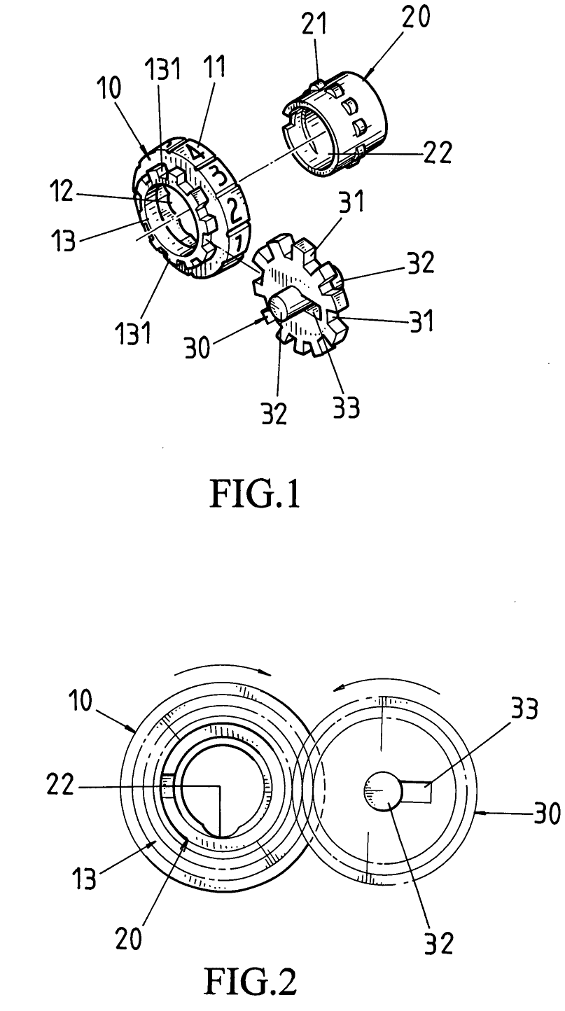

Referring to FIG. 1, which shows the present invention primarily comprising a dial 10 and a notched wheel 20 functioning in coordination with a structure assembled from components including a lock housing, a latch hook and a shaft lever; wherein a plurality of number markings 11 (primarily numbers 0˜9) are circum-located on an outer edge of the dial 10, and a plurality of internal teeth 12 are circum-located on an inner edge of the dial 10. A plurality of external teeth 21 are circum-located on an outer edge wall of the notched wheel 20, and a side edge is provided with a notch 22. When the notched wheel 20 is inserted into the dial 10, the external teeth 21 mutually mesh with the internal teeth 12 of the dial 10. The present invention is primarily characterized in that:

A toothed wheel 13 is located on one side of the dial 10, and the toothed wheel 13 forms an integral body with the dial 10. Moreover, a plurality of external teeth 131 are circum-located on an outer edge of the toothed wheel 13.

Another independent notched wheel 30 is installed at an appropriate position in the lock housing, and a plurality of teeth spacings 31 are circum-located on an outer edge of the notched wheel 30. Referring to FIG. 1 in conjunction with FIG. 2, the teeth spacings 31 of the notched wheel 30 mutually engage with the external teeth 131 of the toothed wheel 13 located on the side of the dial 10. Center of the notched wheel 30 is provided with a rotating shaft 32 that forms an integral body therewith. A notch 33 is defined lateral to the rotating shaft 32 (the center of the notched wheel 3 can be devoid of a rotating shaft and substituted with a round hole configured with a notch). When the number markings 11 on the dial 10 are dialed, apart from the dial 10 actuating and rotating the original notched wheel 20, thereby changing position of the notch 22, moreover, the other toothed wheel-shaped notched wheel 30 is also actuated and rotated, thereby turning the notch 33 of the notched wheel 30. Changing position of the notches 22, 33 of the two notched wheels 20, 30 is used to function in coordination with a protruding piece of the shaft lever of a lock device to accomplish an opening and closing action of the lock. The opening and closing action of the lock utilizes prior art, and is thus not further described hereinafter.

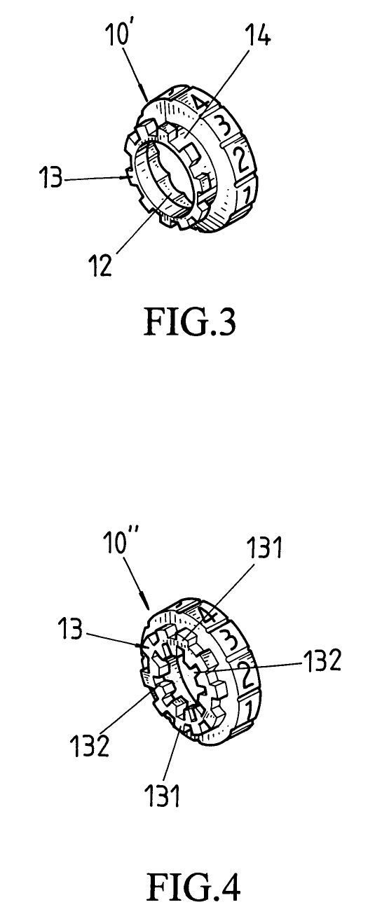

Referring to FIG. 3, which shows another embodiment of the dial for a combination lock of the present invention, wherein a connective neck portion 14 is located between a dial 10′ and the toothed wheel 13 located on a side of the dial 10′, thereby preventing the toothed wheel 13 and the dial 10′ from being in close contact.

Referring to FIG. 4, which shows another embodiment of the dial for a combination lock of the present invention, wherein apart from the plurality of external teeth 131 being circum-located on the outer edge of the toothed wheel 13 located on a side of a dial 10″, moreover, a plurality of internal teeth spacings 132 are circum-located on an inner edge of the toothed wheel 13, and no internal teeth are provided on an inner edge of the dial 10″. Hence, the external teeth 21 of the original notched wheel 20 mutually engage with the internal teeth spacings 132 of the inner edge of the toothed wheel 13.

In conclusion, the present invention provides the dial for a combination lock, wherein the toothed wheel 13 is additionally configured on the side of a conventional type dial. Furthermore, apart from the dial being able to actuate and rotate the original notched wheel 20, moreover, it is able to actuate and rotate the other notched wheel 30 by means of the toothed wheel 13, thereby forming a innovative device that enables the dial to actuate and rotate the two notched wheels 20, 30.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A dial for a combination lock, comprising a wheel-shaped member, center of which is a through hole, disposed with at least two toothed wheels, wherein at least one is an internal toothed wheel, and at least one is an external toothed wheel.

2. The dial for a combination lock according to claim 1, wherein a plurality of teeth spacings circum-located on an outer edge of an additional notched wheel mutually engage with external teeth on the toothed wheel of the dial.

3. The dial for a combination lock according to claim 2, wherein a center of the additional notched wheel is provided with a rotating shaft, lateral to which is provided with a notch.

4. The dial for a combination lock according to claim 2, wherein the center of the additional notched wheel is devoid of a rotating shaft, but provided with a notched round hole.

5. The dial for a combination lock according to claim 1, wherein a connective neck portion is located between the toothed wheel located on a side of the dial and the dial.

6. The dial for a combination lock according to claim 1, wherein a plurality of external teeth are circum-located on an outer edge of the toothed wheel located on the side of the dial, and a plurality of internal teeth spacings are circum-located on an inner edge of the toothed wheel; an inner edge of the dial is not configured with internal teeth, and external teeth of the original notched wheel mutually engage with the internal teeth spacings of the toothed wheel.
